(19) United States
(12) Patent Application Publication
(10) Pub. No.: US 2024/0104482 A1
(43) Pub. Date: Mar. 28, 2024

(54) ANTI-FATIGUE AND SAFETY CONTROL METHOD FOR ULTRA-LONG LIFE SERVICE STRUCTURES UNDER EXTREME ENVIRONMENT

(71) Applicant: East China University of Science and Technology, Shanghai (CN)

(72) Inventors: Mingliang ZHU, Shanghai (CN); Fuzhen XUAN, Shanghai (CN); Gang ZHU, Shanghai (CN); Shan-Tung TU, Shanghai (CN)

(73) Assignee: East China University of Science and Technology, Shanghai (CN)

(21) Appl. No.: 18/227,069

(22) Filed: Jul. 27, 2023

Related U.S. Application Data
(63) Continuation of application No. PCT/CN2022/119223, filed on Sep. 16, 2022.

(51) Int. Cl. G06Q 10/0639; G05B 23/02; G06Q 10/067; G06Q 50/04; G06Q 50/26

(52) U.S. Cl. CPC G06Q 10/06395; G05B 23/0283; G06Q 10/067; G06Q 50/04; G06Q 50/265

(57) ABSTRACT

An anti-fatigue and safety control method for ultra-long life service structures under extreme environment, comprising: judge the fatigue fracture mode in the long life stage of the service structure; according to the interaction principle of defect-matrix, obtain the internal defect induced fatigue cracking mechanism in ultra-high cycle regime under the service environment; considering the environmental factors, clarify the internal defect-matrix-environment interaction mechanism under service conditions and obtain the environmental weakening coefficient; considering the environmental factors, establish a fatigue life prediction model based on defect-load-life correlation under service conditions in ultra-high cycle regime; the process parameters of material metallurgy and manufacturing, design parameters of structural strength, structural service stress and environmental parameters are regulated based on the concept of integrated design/manufacturing.

### CROSS-REFERENCE TO RELATED APPLICATION

This application is a continuation under 35 U.S.C. § 111(a) of PCT International Application No. PCT/CN2022/119223, filed Sep. 16, 2022, the contents of which are incorporated herein by reference in its entirety.

### TECHNICAL FIELD

The invention relates to the technical field of mechanical structure strength and intelligent manufacturing of high-end equipment, more specifically, relates to an anti-fatigue and safety control method for ultra-long life service structures under extreme environment.

### BACKGROUND

Fatigue failure of structures is one of the most typical failure modes in engineering. According to the cyclic number, it can be divided into low cycle fatigue, high cycle fatigue and ultra-high cycle fatigue.

In the past two decades, modern engineering equipment and components such as nuclear power equipment, engine parts, automotive bearing parts, railway wheels and rails, aircraft, coastal structures, and bridges have shown a new trend of low stress and long life service.

At present, the anti-fatigue performance of long-life service structures can be improved in the following two ways:

The first way is to directly choose high-strength materials;

However, the higher the strength level of the material, the higher the sensitivity to defects or environmental induced fracture, that is, it is not feasible to rely on improving the strength level of the material to obtain high fatigue resistance, which makes people realize that “the fracture of the structure is not only a problem of the material”;

The second way is the existing widely used surface reinforcement technology;

The technology can extend the structure fatigue life, mainly based on the concept of anti-fatigue manufacturing, by changing the material surface of the microstructure, chemical composition and stress state, however, the surface reinforcement technology makes it is easier for induced fracture in the structure to germinate in the internal defects under the condition of long life, the results of adopting the surface reinforcement technology to improve the anti-fatigue performance is that the structure finally present high cycle fatigue characteristics, which makes people realize that “surface reinforcement cannot effectively prevent fatigue fracture”.

Therefore, it is urgent to develop new methods and technologies to regulate the fatigue fracture of engineering structures with ultra-long-life service requirement.

### SUMMARY

The purpose of this invention is to provide an anti-fatigue and safety control method for ultra-long life service structures under extreme environment, so as to solve the difficulty of fatigue damage prevention of ultra-long-life service structures.

In order to achieve the above purpose, the invention provides an anti-fatigue and safety control method for ultra-long life service structures under extreme environment, comprising the following steps:
Step S1: judge the fatigue fracture mode in the long life stage of the service structure, and if the fracture mode is an internal defect, proceed to step S2;
Step S2: according to the interaction principle of defect-matrix, obtain the internal defect induced fatigue cracking mechanism in ultra-high cycle regime under the service environment;
Step S3: considering the environmental factors, clarify the internal defect-matrix-environment interaction mechanism of ultra-high cycle fatigue under service conditions and obtain the environmental weakening coefficient;
Step S4: considering the environmental factors, establish a fatigue life prediction model based on defect-load-life correlation under service conditions in ultra-high cycle regime;
Step S5: according to the fatigue life prediction model on defect-load-life correlation under service conditions in ultra-high cycle regime, regulate the process parameters of material metallurgy and manufacturing, design parameters of structural strength, structural stress and environmental parameters are regulated based on the concept of integrated design/manufacturing.

In one embodiment, the step S1, further comprising the steps of:

Judge the fatigue fracture mode in the long life stage of the service structure, if the mode is surface defect induced fracture mode, carry out the anti-fatigue and safety regulation according to the traditional anti-fatigue theory model.

In one embodiment, the traditional anti-fatigue theory model includes Manson-Coffin model and Basquin model.

In one embodiment, the interaction principle of defect-matrix in the step S2 is that local plasticity around the defect leads to matrix damage under continuously cyclic load.

In one embodiment, the internal defect-matrix-environment interaction mechanism in the step S3 is that local plasticity around the defect, coupling of chemical elements and temperature lead to matrix damage under continuously cyclic load.

In one embodiment, the expression corresponding to the environment weakening coefficient H in the step S3 is:

$$H = \frac{{σ}_{( environment )}}{{σ}_{( air )}} or H = \frac{{N}_{( environment )}}{{N}_{( air )}}$$

σ₍ₑₙᵥᵢᵣₒₙₘₑₙₜ₎ is the fatigue strength under the service conditions;
σ₍ₐᵢᵣ₎ is the fatigue strength under the air environment;
N₍ₑₙᵥᵢᵣₒₙₘₑₙₜ₎ is the fatigue life under service conditions;
N₍ₐᵢᵣ₎ is the fatigue life under the air environment.

In one embodiment, the corresponding expression of the theoretical prediction model for the ultra-high cycle fatigue life in the step S4 is:

$${Z}^{α} {N}_{f} = C ;$$

$$Z = Y {{σ}_{a} ( \sqrt{area} )}^{1 / 6} {D}^{β} ( \frac{1 - R}{2} ) ;$$

$$D = ( d - {d}_{inc} ) / d ;$$

wherein, σₐ is the fatigue stress amplitude;
area is the microdefect projection area;
D is the relative position of the defect;
α, C are the fitting constants;
N_{f} is the fatigue life;
β is the material constant, which is related to the H in S3;
d is the diameter of the fatigue test rod;
d_{inc} is the minimum distance from the central point of the defect to the outer surface of the test rod;
R is the stress ratio, whose range is from −1 to 1;
Z is the fatigue life control parameter.

In one embodiment, the process parameters of material metallurgy and manufacturing are regulated according to the theoretical prediction model in the step S5, further comprising the following steps:
Step S511: Control the metallurgy and production process according to the theoretical prediction model, and carry out material design and material manufacturing;
Step S512: Conduct the fatigue test of the material and evaluate the test data;
Step S513: Compare the evaluation results with the expected indicators, if the evaluation results meet the requirements of the expected indicators, then the current material is an ultra-long-life anti-fatigue material, and the process is over, if the evaluation results do not meet the requirements of the expected indicators, then the metallurgical and manufacturing process parameters are regulated and return to step S511 until the evaluation results meet the requirements of the expected indicators.

In one embodiment, design parameters of structural strength are regulated according to the fatigue life prediction model in ultra-high cycle fatigue regime in the step S5, further comprising the following steps:
Step S521: according to the fatigue fracture mode in the long life stage of the service structure, carry out the structural and material fatigue design and obtain structural strength design parameters;
Step S522: verify and check the structural strength design parameters based on the fatigue life prediction model in ultra-high cycle fatigue regime;
Step S523: Compare the verification results with the design requirements, if the verification results meet the design requirements, then the current structural strength design parameters are ultra-long-life anti-fatigue design parameters, and the process is over, if the verification results do not meet the design requirements, then return to step S521 to regulate the structural strength design parameters until the verification results meet the design requirements.

In one embodiment, the structural service stress and environmental parameters are regulated according to the fatigue life prediction model in ultra-high cycle fatigue regime in the step S5, further comprising the following steps:
Step S531. Establish a digital twin model with the fatigue life prediction model in ultra-high cycle fatigue regime combined with the structural strength design parameters;
Step S532. carry out the security simulation analysis of the digital twin model;
Step S533. If the security simulation output result is safe, then the current service stress and environmental parameters meet the requirements, and the process is over, if the security simulation output result is unsafe, then the service stress and environmental parameters are regulated, and return to the step S531 until the security simulation output result is safe.

An anti-fatigue and safety control method of service structure for ultra-long life service structures proposed by the invention, combing material metallurgy, structure design and manufacturing process, considering the failure fatigue of service structure in ultra-long life regime, and considering the coupling effect of design and manufacturing, can enhance the coordination of design and manufacturing, shorten the design and manufacturing process, effectively improve the anti-fatigue ability of material and structure, thus ensure the safety operation and maintenance of service structures.

### BRIEF DESCRIPTION OF DRAWINGS

The above and other features, properties and advantages of the invention will become more apparent from the following description in conjunction with the figures and embodiments, in which the same reference numerals represent the same features throughout, wherein:

FIG. 1 discloses a flow chart of an anti-fatigue and safety control method for ultra-long life service structures based on design/manufacturing integration according to an embodiment of the invention;

FIG. 2 discloses a flow chart of ultra-long life anti-fatigue material regulation case according to an embodiment of the invention;

FIG. 3 discloses a flow chart of ultra-long life anti-fatigue structural regulation case according to an embodiment of the invention;

FIG. 4 discloses a flow chart of ultra-long life safe service regulation case according to an embodiment of the invention.

### DETAILED DESCRIPTION

In order to make the object, technical solution and advantages of the invention clearer, the invention will be further described in detail below with reference to the attached figures and embodiments. It should be understood that the specific embodiments described here are only used to explain the invention, and are not intended to limit the invention.

It is found that most structures undergoing long-life cycle loading crack from internal defects, which makes the cracking due to internal defect become a typical feature of ultra-high structural fatigue failure.

It's deemed that, on the basis of knowing internal micro defects are the essential attributes of ultra-high cycle fatigue fracture, the anti-fatigue method of defect-containing materials should focus on the defect-matrix relationship and the external environmental factors that can influence this relationship.

The occurrence of internal defects is related to the material metallurgical factors, and the performance of the material matrix depends on the design and manufacturing process, and the environmental factors represent the service conditions. The combination of the three requires the coordination and unity of the material design, metallurgy and manufacturing process and the service environment.

The ultimate goal of super high cycle fatigue research is to “seek the method of preventing structure failure” to ensure the safety and reliability of the long life of the structure.

Based on the above analysis, the anti-fatigue and safety control method for ultra-long life service structures under extreme environment proposed by the invention, considering the influence of material strength, internal defects and external environment, by optimizing the alloy composition design and the metallurgical condition, structure manufacturing process and service conditions, establish “design/manufacturing integration” structural fatigue damage prevention technology to realize the long-life safe operation and maintenance of the service structure.

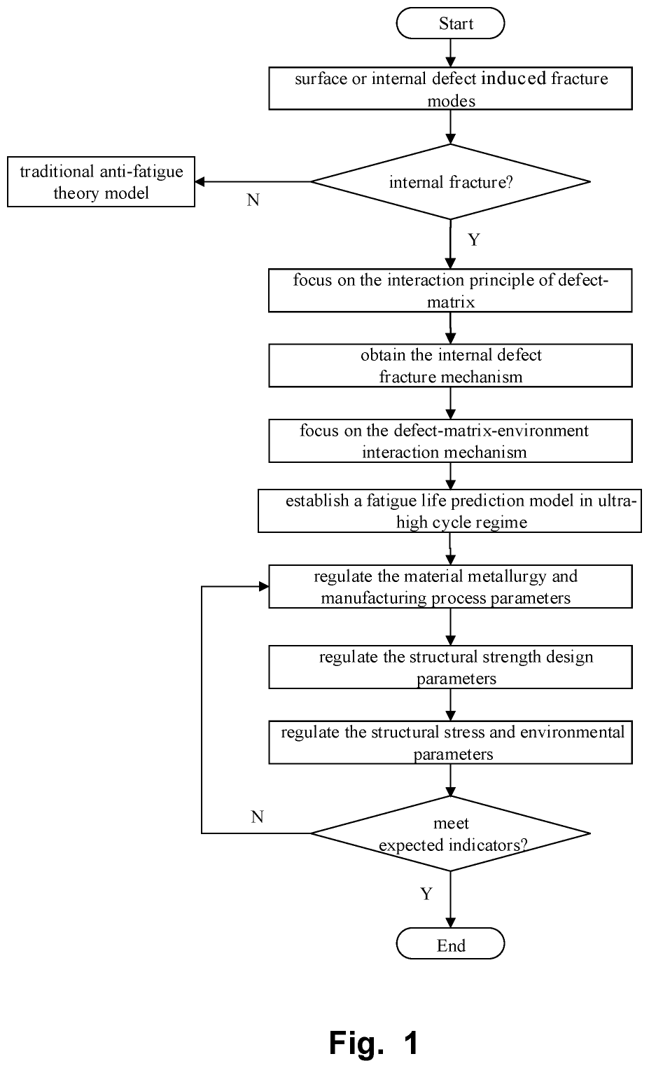

FIG. 1 discloses a flow chart of an anti-fatigue and safety control method for ultra-long life service structures based on design/manufacturing integration according to an embodiment of the invention. As shown in FIG. 1, the anti-fatigue and safety control method for ultra-long life service structures under extreme environment, comprising the following steps:
Step S1: judge the fatigue fracture mode in the long life stage of the service structure, and if the fracture mode is internal defect induced fracture mode, proceed to step S2;
Step S2: according to the interaction principle of defect-matrix, obtain the internal defect induced fatigue cracking mechanism in ultra-high cycle regime under the service environment;
Step S3: considering the environmental factors, clarify the internal defect-matrix-environment interaction mechanism of ultra-high cycle fatigue under service conditions and obtain the environmental weakening coefficient;
Step S4: considering the environmental factors, establish a fatigue life prediction model based on defect-load-life correlation under service conditions in ultra-high cycle regime;
Step S5: according to the fatigue life prediction model on defect-load-life correlation under service conditions in ultra-high cycle regime, regulate the process parameters of material metallurgy and manufacturing, design parameters of structural strength, structural stress and environmental parameters are regulated based on the concept of integrated design/manufacturing.

The invention provides the method and system for anti-fatigue and safety regulation for ultra-long life service structures in the extreme environment based on the design/manufacturing integration. The coupling effect of design and manufacturing considered simultaneously in the anti-fatigue design can shorten the design and manufacturing process and effectively improve the anti-fatigue ability of materials and structures.

As a common basic technology, this method reflects the integrated life-cycle of design, manufacturing and operation, operation and maintenance, promotes the compatibility and coordination of material design, metallurgy and manufacturing process, and supports the anti-fracture design, manufacturing and operation maintenance of the ultra-long life service structure of the series of high-end equipment.

These steps are described in detail below. It should be understood that within the scope of the invention, the above technical features of the invention and the technical features described below (as in the embodiment) can be combined and associated with each other to constitute a preferred technical solution.

Step S1: judge the fatigue fracture mode in the long life stage of the service structure, and if the fracture mode is internal defect induced fracture mode, proceed to step S2.

Further, if the mode is surface defect induced fracture mode, the anti-fatigue and safety regulation are carried out according to the traditional anti-fatigue theory model.

The fatigue fracture mode of long-life service structure is divided into surface defect caused fracture and internal defect induced fracture.

In step S1, the surface and internal fracture caused modes are distinguished. If the surface defect caused fracture mode occurs, the design against fatigue is conducted according to the traditional anti-fatigue theory model; if the internal defect induced fracture mode occurs, the step S2 for the design against fatigue is conducted.

Traditional theoretical models of fatigue resistance mainly include Manson-Coffin model and Basquin model.

For the fatigue damage and life prediction of materials, the classical Basquin and Manson-Coffin formula respectively choose the stress amplitude and strain amplitude as parameters for evaluation.

The Manson-Coffin model is a famous strain-life relationship model. It is used to directly predict the limited life of constant fatigue. In addition to uniform materials, there are welded joints and new materials, which are also extended to short fatigue, variable amplitude fatigue, etc.

The Basquin model is used to describe the S-N curve relationship between the fatigue life and the stress amplitude.
Step S2: according to the interaction principle of defect-matrix, obtain the internal defect induced fatigue fracture cracking mechanism in ultra-high cycle regime under the service environment.

The described interaction principle of matrix-defect is that the local plasticity around the defect leads to matrix damage under continuously cyclic load.
Step S3: considering the environmental factors, clarify the internal defect-matrix-environment interaction mechanism of ultra-high cycle fatigue under service conditions and obtain the environmental weakening coefficient.

The described the internal defect-matrix-environment interaction mechanism in the step S3 is that local plasticity around the defect, coupling of chemical elements and temperature lead to matrix damage under continuously cyclic load.

Further, the expression corresponding to the environmental weakening coefficient H is:

$$H = \frac{{σ}_{( environment )}}{{σ}_{( air )}} or H = \frac{{N}_{( environment )}}{{N}_{( air )}}$$

σ₍ₑₙᵥᵢᵣₒₙₘₑₙₜ₎ is the fatigue strength under the service conditions;
σ₍ₐᵢᵣ₎ is the fatigue strength under the air environment;
N₍ₑₙᵥᵢᵣₒₙₘₑₙₜ₎ is the fatigue life under service conditions;
N₍ₐᵢᵣ₎ is the fatigue life under the air environment.
Step S4: considering the environmental factors, establish a fatigue life prediction model based on defect-load-life correlation under service conditions in ultra-high cycle regime.

Combined with the environmental weakening coefficient and fracture mechanism of internal micro defects, the theoretical model comprehensively considers the geometric size, position, morphology, the influencing factors of matrix performance and the environmental influencing factors.

In this embodiment, the fatigue life prediction model in ultra-high cycle regime, the corresponding expression is:

$${Z}^{α} {N}_{f} = C ;$$

$$Z = Y {{σ}_{a} ( \sqrt{area} )}^{1 / 6} {D}^{β} ( \frac{1 - R}{2} ) ;$$

$$D = ( d - {d}_{inc} ) / d ;$$

wherein, σₐ is the fatigue stress amplitude;
area is the microdefect projection area;
D is the relative position of the defect;
α, C are the fitting constants;
N_{f} is the fatigue life;
β is the material constant, which is related to the H in S3;
d is the value of d is the diameter of the fatigue test rod;
d_{inc} is the minimum distance from the central point of the defect to the outer surface of the test rod;
R is the stress ratio, whose range is from −1 to 1;
Z is the fatigue life control parameter.

More specifically, the stated din, is the minimum distance from the central point of the defect in the fatigue fracture SEM photo to the outer surface of the test rod which can be used by Image analysis software to measure.
Step S5: according to the fatigue life prediction model on defect-load-life correlation under service conditions in ultra-high cycle regime, regulate the process parameters of material metallurgy and manufacturing, design parameters of structural strength, structural stress and environmental parameters based on the concept of integrated design/manufacturing.

In step S5, the material metallurgy and manufacturing process parameters are regulated according to the fatigue life prediction model in ultra-high cycle fatigue regime.

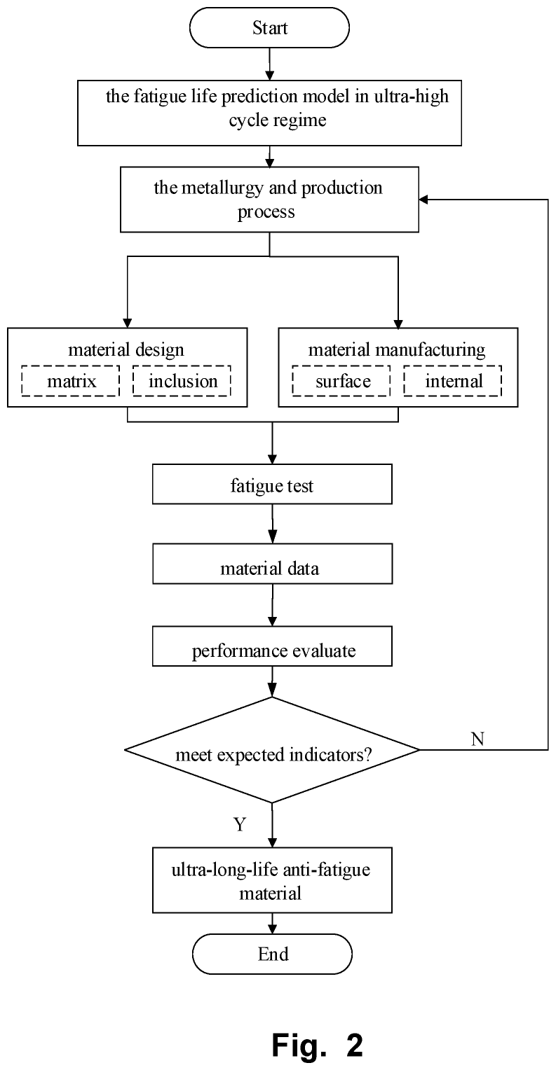

FIG. 2 discloses a flow chart of ultra-long life anti-fatigue material regulation case according to an embodiment of the invention. As shown in FIG. 2, the material metallurgy and manufacturing process parameters are regulated according to the theoretical model in step S5, further comprising the following steps:
Step S511: control the metallurgy and production process according to the theoretical model, and carry out material design and material manufacturing;

The metallurgy and manufacturing process are regulated according to the theoretical model, and the process parameters of material design and manufacturing are regulated according to the fatigue life prediction model.

Wherein, material design includes reinforcing matrix and reduced inclusion size, and material fabrication includes surface fabrication or internal fabrication.
Step S512: conduct the fatigue test of the material and evaluate the test data;
Step S513: compare the evaluation results with the expected indicators, if the evaluation results meet the requirements of the expected indicators, then the current material is an ultra-long-life anti-fatigue material, and the process is over, if the evaluation results do not meet the requirements of the expected indicators, then the metallurgical and manufacturing process parameters are regulated and return to step S511 until the evaluation results meet the requirements of the expected indicators.

In step S5, the design parameters of structural strength are further regulated based on the fatigue life prediction model in ultra-high cycle regime.

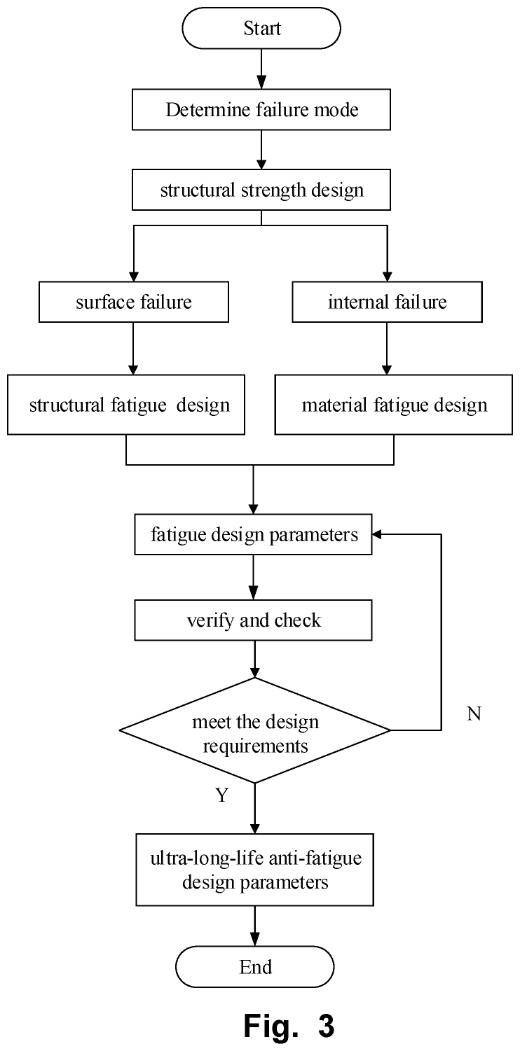

FIG. 3 discloses a flow chart of ultra-long life anti-fatigue structural regulation case according to an embodiment of the invention, as shown in FIG. 3, design parameters of structural strength are regulated according to the fatigue life prediction model in ultra-high cycle regime in the step S5, further comprising the following steps:
Step S521: according to the fatigue fracture mode in the long life stage of the service structure, carry out structure and material fatigue design and obtain structural strength design parameters;

The structural strength design parameters are regulated according to the properties of ultra-long life anti-fatigue materials.

The structural strength is designed according to the fatigue fracture mode in the long life stage of the service structure (short of failure mode).

The structural fatigue is designed for surface defect caused fracture mode (surface failure);

The material fatigue is designed for internal defect induced fracture mode (internal failure);

Finally, the fatigue design parameters obtained by the structural fatigue design and the material fatigue design are unified as the structural strength design parameters.
Step S522: verify and check the structural strength design parameters based on the fatigue life prediction model in ultra-high cycle fatigue regime;
Step S523: compare the verification results with the design requirements, if the verification results meet the design requirements, then the current structural strength design parameters are ultra-long-life anti-fatigue design parameters, and the process is over, if the verification results do not meet the design requirements, then return to step S521 to regulate the structural strength design parameters until the verification results meet the design requirements.

The design model corresponding to the ultra-long life fatigue design parameters is used as the ultra-long life anti-fatigue design model.

In step S5, the structural service stress and environmental parameters are further regulated, and the structural service stress and environmental parameters are regulated according to the ultra-long life anti-fatigue material and structural strength design parameters.

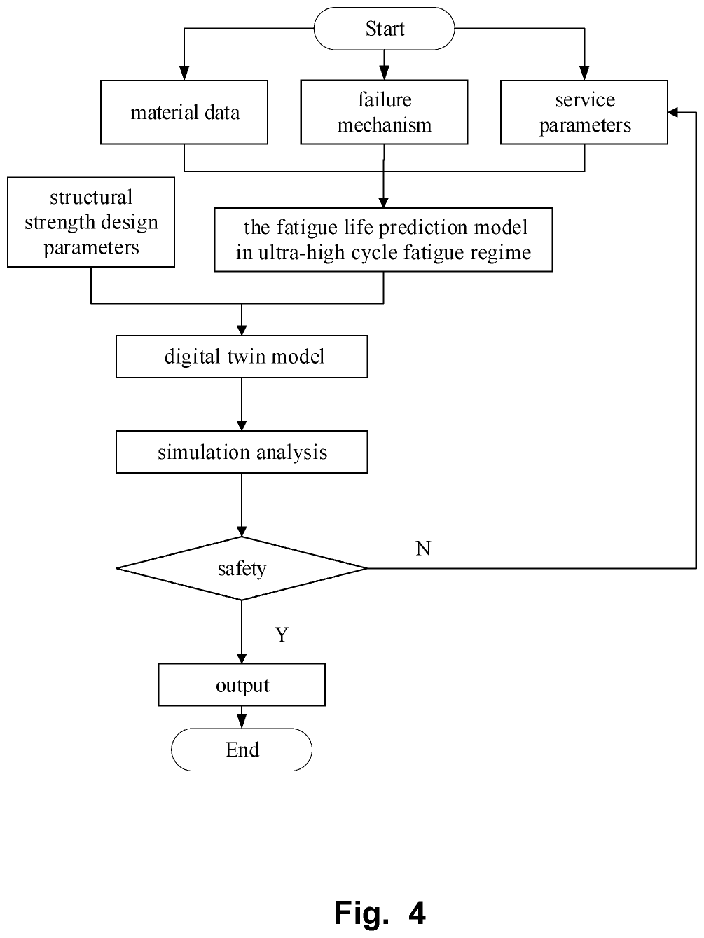

FIG. 4 discloses a flow chart of ultra-long life safe service regulation case according to an embodiment of the invention, as shown in FIG. 4, the structural service stress and environmental parameters are regulated according to the fatigue life prediction model in ultra-high cycle fatigue regime in the step S5, further comprising the following steps:
Step S531: establish a digital twin model with the fatigue life prediction model in ultra-high cycle fatigue regime combined with the structural strength design parameters;

The service stress and environmental parameters (hereinafter referred to as the service parameters) are updated together with the ultra-long life anti-fatigue material data and failure mechanism obtained in the above steps to establish the theoretical model of ultra-high cycle fatigue life prediction.

Service parameters include the stress level and the environmental parameters.

According to the established fatigue life prediction model in ultra-high cycle fatigue regime, the digital model reflecting the real-time service state of the physical entity is established combined with structural strength design parameters. In this embodiment, the digital model is a digital twin model.

Digital twin is to make full use of physical model, sensor update, operation history and other data, integrate multi-disciplinary, multi-physical quantity, multi-scale, multi-probability simulation process, and complete the mapping in the virtual space, so as to reflect the whole life cycle process of the corresponding physical equipment.
Step S532: carry out the security simulation analysis of the digital twin model;

In this embodiment, the digital twin model is embedded in the simulation software for security simulation analysis.
Step S533: if the security simulation output result is safe, then the current service stress and environmental parameters meet the requirements, and the process is over, if the security simulation output result is unsafe, then the service stress and environmental parameters are regulated, and return to the step S531 until the security simulation output result is safe.

Although the above methods are illustrated and described as a series of acts for simplicity of explanation, it is to be understood and appreciated that the methodologies are not limited by the order of the acts. As in accordance with one or more embodiments, some acts may occur in different orders and/or concurrently with other acts from those shown and described herein or not shown and described herein but would be appreciated by those skilled in the art.

In order to make the purpose, technical scheme and advantages of the implementation of this application more clear, the anti-fatigue design of the power station turbine blade and the illustrated drawings of the embodiment in this application.

From the failure analysis case, the damage mode of the turbine blade is a typical environmental ultra-high cycle fatigue damage. Try to implement the anti-fatigue design of the turbine blade according to the anti-fatigue and safety control method of the ultra-long life service structure disclosed in the present invention. The specific steps are as follows:
Step S1: determine the fatigue fracture mode of the long-life stage of the steam turbine blade;

The long life stage fatigue fracture mode of steam turbine blade includes surface defect induced fracture mode and internal defect induced fracture mode;
Step S2: For internal defect induced fracture mode, the internal defect induced fracture cracking mechanism in ultra-high cycle fatigue of steam turbine blade is further determined.

According to the interaction principle of defect-matrix, the principle of ultra-high peripheral fatigue in the air environment of steam turbine blade is that local plasticity around the defect leads to matrix damage under continuously cyclic load.
Step S3: considering environmental factors, clarify steam turbine blade under the condition of internal defect-matrix-environment interaction mechanism and obtain the environmental weakening coefficient, obtain steam turbine blade service conditions (corrosion environment) on the mechanism of internal defects;

Since the blade is served in the steam or brine environment, considering the environmental impact, it is further characterized to find that a large amount of hydrogen is around the defect, so the main environmental influence factor is the influence of hydrogen.

Therefore, the mechanism of internal defect induced fracture mode needs to consider the effect of hydrogen on the fatigue damage of the matrix around the defect.
Step S4: considering the environmental factors and the influence of matrix-defect-hydrogen, combine the failure mechanism and environmental weakening coefficient to establish the fatigue life prediction model on defect-load-life correlation in ultra-long life regime.

In this embodiment, the fatigue life prediction model in ultra-high cycle regime, the corresponding expression is

$${Z}^{α} {N}_{f} = C ;$$

$$Z = Y {{σ}_{a} ( \sqrt{area} )}^{1 / 6} {D}^{β} ( \frac{1 - R}{2} ) ;$$

$$D = ( d - {d}_{inc} ) / d ;$$

wherein, σₐ is the fatigue stress amplitude; area is the microdefect projection area, α, C are the fitting constants, N_{f} is the fatigue life, D is the relative position of the defect, β is the material constant, which is affected by the environment, d is the diameter of the fatigue test rod, d_{inc} is the minimum distance from the central point of the defect to the outer surface of the test rod, R is the stress ratio, whose range is from −1 to 1, and Z is the fatigue life control parameter.
Step S5: according to the fatigue life prediction model in ultra-high cycle regime, the material metallurgy and manufacturing process parameters, structural strength design parameters, structural service stress and environmental parameters are regulated based on the concept of integrated design/manufacturing.

More specifically, step S5 further comprises the following steps:
Step S51: as shown in FIG. 2, regulate the material metallurgy and manufacturing process parameters to obtain ultra-long-life anti-fatigue materials;
Step S52: as shown in FIG. 3, regulate the structural strength design parameters to obtain the ultra-long life anti-fatigue design model;
Step S53: as shown in FIG. 4, regulate the structural service stress and environmental parameters to ensure the safety of the design service.

An anti-fatigue and safety control method of service structure for ultra-long life service structures proposed by the invention, combing material metallurgy, structure design and manufacturing process, considering the fatigue failure of service structure in ultra-long life regime, and considering the coupling effect of design and manufacturing, can shorten the design and manufacturing process, effectively improve the anti-fatigue ability of material and structure, thus ensure the safety operation and maintenance of service structures.

As shown in the present application and claims, “one,” “one,” “one,” and “one” and/or “one” are not singular, unless the context clearly indicates the exception. In general, the terms “include” and “include” hint only at the steps and elements clearly identified that do not constitute an exclusive list, and the method or device may also contain other steps or elements.

Those skilled in the art will further understand that the various interpretive logic plates, modules, circuits, and algorithm steps described in combination with the embodiments disclosed herein may be implemented as electronic hardware, computer software, or a combination of the two. In order to clearly explain this interchangeability of hardware and software, the various explanatory components, boxes, modules, circuits, and steps are generally described in their functional form above. Whether such functionality is implemented as hardware or software depends on the specific application and the design constraints imposed on the overall system. The technician can achieve the described functionality differently for each particular application, but such an implementation decision should not be interpreted as resulting away from the scope of the invention.

The above embodiments are provided to those familiar with the field to implement or use the invention, and the above embodiment may be changed without departing from the inventive ideas of the invention, so that the protection scope of the invention is not limited by the above embodiments, but should be the maximum range of the innovative features mentioned in the claim.

1. An anti-fatigue and safety control method for ultra-long life service structures under extreme environment, comprising the following steps:
Step S1: judge the fatigue fracture mode in the long life stage of the service structure, and if the fracture mode is internal defect induced fracture mode, proceed to step S2;
Step S2: according to the interaction principle of defect-matrix, obtain the internal defect induced fatigue cracking mechanism in ultra-high cycle regime under the service environment;
Step S3: considering the environmental factors, clarify the internal defect-matrix-environment interaction mechanism of ultra-high cycle fatigue under service conditions and obtain the environmental weakening coefficient;
Step S4: considering the environmental factors, establish a fatigue life prediction model based on defect-load-life correlation under service conditions in ultra-high cycle regime;
Step S5: according to the fatigue life prediction model on defect-load-life correlation under service conditions in ultra-high cycle regime, regulate the process parameters of material metallurgy and manufacturing, design parameters of structural strength, structural stress and environmental parameters based on the concept of integrated design/manufacturing.

2. The method of claim 1, wherein the step S1 further comprising the steps of:
judge the fatigue fracture mode in the long life stage of the service structure, if the mode is surface defect induced fracture mode, carry out the anti-fatigue and safety regulation according to the traditional anti-fatigue theory model.

3. The method of claim 2, wherein the traditional anti-fatigue theory model includes Manson-Coffin model and Basquin model.

4. The method of claim 1, wherein the interaction principle of defect-matrix in the step S2 is that local plasticity around the defect leads to matrix damage under continuously cyclic load.

5. The method of claim 1, wherein the internal defect-matrix-environment interaction mechanism in the step S3 is that local plasticity around the defect, coupling of chemical elements and temperature lead to matrix damage under continuously cyclic load.

6. The method of claim 1, wherein the expression corresponding to the environment weakening coefficient H in the step S3 is:
$$H = \frac{{σ}_{( environment )}}{{σ}_{( air )}} or H = \frac{{N}_{( environment )}}{{N}_{( air )}}$$
σ₍ₑₙᵥᵢᵣₒₙₘₑₙₜ₎ is the fatigue strength under the service conditions;
σ₍ₐᵢᵣ₎ is the fatigue strength under the air environment;
N₍ₑₙᵥᵢᵣₒₙₘₑₙₜ₎ is the fatigue life under service conditions;
N₍ₐᵢᵣ₎ is the fatigue life under the air environment.

7. The method of claim 1, wherein the corresponding expression of the fatigue life prediction model in ultra-high cycle regime in the step S4 is:
$${Z}^{α} {N}_{f} = C ;$$
$$Z = Y {{σ}_{a} ( \sqrt{area} )}^{1 / 6} {D}^{β} ( \frac{1 - R}{2} ) ;$$
$$D = ( d - {d}_{inc} ) / d ;$$
wherein, σₐ is the fatigue stress amplitude;
area is the microdefect projection area;
D is the relative position of the defect;
α, C are the fitting constants;
N_{f} is the fatigue life;
β is the material constant, which is related to the H in S3;
d is the diameter of the fatigue test rod;
d_{inc} is the minimum distance from the central point of the defect to the outer surface of the test rod;
R is the stress ratio, whose range is from −1 to 1;
Z is the fatigue life control parameter.

8. The method of claim 1, wherein the regulating the process parameters of material metallurgy and manufacturing according to the fatigue life prediction model in ultra-high cycle regime in the step S5 further comprising the following steps:
Step S511: control the metallurgy and production process according to the theoretical prediction model, and carry out material design and material manufacturing;
Step S512: conduct the fatigue test of the material and evaluating the test data;
Step S513: compare the evaluation results with expected indicators, if the evaluation results meet the requirements of the expected indicators, then the current material is an ultra-long-life anti-fatigue material, and the process is over, if the evaluation results do not meet the requirements of the expected indicators, then regulate the metallurgical and manufacturing process parameters and return to step S511 until the evaluation results meet the requirements of the expected indicators.

9. The method of claim 1, wherein the regulating the design parameters of structural strength according to the fatigue life prediction model in ultra-high cycle regime in the step S5 further comprising the following steps:
Step S521: according to the fatigue fracture mode in the long life stage of the service structure, carry out the structural and material fatigue design and obtaining structural strength design parameters;
Step S522: verify and check the structural strength design parameters based on the fatigue life prediction model in ultra-high cycle fatigue regime;
Step S523: compare the verification results with the design requirements, if the verification results meet the design requirements, then the current structural strength design parameters are ultra-long-life anti-fatigue design parameters, and the process is over, if the verification results do not meet the design requirements, then return to step S521 to regulate the structural strength design parameters until the verification results meet the design requirements.

10. The method of claim 1, wherein the regulating the structural service stress and environmental parameters according to the fatigue life prediction model in ultra-high cycle fatigue regime in the step S5 further comprising the following steps:
Step S531: establish a digital twin model with the fatigue life prediction model in ultra-high cycle fatigue regime combined with the structural strength design parameters;
Step S532: carry out the security simulation analysis of the digital twin model;
Step S533: if the security simulation output result is safe, then the current service stress and environmental parameters meet the requirements, and the process is over, if the security simulation output result is unsafe, then regulate the service stress and environmental parameters, and return to the step S531 until the security simulation output result is safe.
